(19) United States
(12) Patent Application Publication
(10) Pub. No.: US 2022/0234547 A1
(43) Pub. Date: Jul. 28, 2022

(54) ROTATING WINDOW SENSOR CLEANING SYSTEM

(71) Applicant: DY AUTO Corporation, Asan-si (KR)

(72) Inventor: Jeong Goo Lee, Asan-si (KR)

(73) Assignee: DY AUTO Corporation, Asan-si (KR)

(21) Appl. No.: 17/546,014

(22) Filed: Dec. 8, 2021

(30) Foreign Application Priority Data
Jan. 22, 2021 (KR) 10-2021-0009519

(51) Int. Cl. B60S 1/56; B60S 1/04; B60S 1/52

(52) U.S. Cl. CPC B60S 1/566; B60S 1/52; B60S 1/0402

(57) ABSTRACT

A rotating window sensor cleaning system according to the disclosure includes: a frame having a space therein; a camera or a sensor fixed inside the frame; a transparent window arranged in front of the camera or the sensor and mounted to be rotatable with respect to the frame; and a wiper blade fixed to the frame and mounted to be in sliding contact with the window, wherein the window is configured to be rotated by a motor fixed to the frame.

### CROSS-REFERENCE TO RELATED APPLICATION

This application is based on and claims priority under 35 U.S.C. §119 to Korean Patent Application No. 10-2021-0009519, filed on Jan. 22, 2021, in the Korean Intellectual Property Office, the disclosure of which is incorporated by reference herein in its entirety.

### BACKGROUND

### 1. Field

The disclosure relates to a sensor cleaning system capable of quickly and effectively removing foreign matter from a front transparent window of a camera or a sensor used in an autonomous vehicle or the like.

### 2. Description of the Related Art

In general, in a vehicle having an autonomous driving function, one or more cameras or sensors are mounted to measure a distance from the vehicle to an object in front or behind the vehicle. Such cameras or sensors are frequently mounted outside the vehicle. For example, cameras that capture images of a situation in front of the vehicle or sensors may be mounted on a bumper or a radiator grill of the vehicle. However, cameras or sensors mounted outside the vehicle may be easily contaminated by rain, snow, dust, or the like. Accordingly, a cleaning system for removing foreign matter is mounted in a camera or sensor device mounted outside the vehicle. An example of such a cleaning system is disclosed in Korean Patent Publication No. 10-2019-0021644. However, in the structure disclosed in the above patent publication, a wiper blade is mounted to wipe the surface of a lens or glass, and the wiper blade is configured to reciprocate in left and right directions by a motor. Because the cleaning system has such a structure in which a blade passes in front of a camera or sensor device, sensing errors may occur when the camera or sensor device operates. Also, in the structure of the above patent publication wherein the blade mechanically moves on the outside of the vehicle, a wiper system may be damaged by an unexpected impact.

### SUMMARY

The disclosure has been devised to solve the problems as described above, and provides a cleaning system in which a structure of a cleaning system of a camera or sensor mounted outside a vehicle is improved to prevent malfunction of the camera or sensor during a cleaning process, and cleaning components do not protrude to the outside so that assemblability and durability thereof are improved.

Additional aspects will be set forth in part in the description which follows and, in part, will be apparent from the description, or may be learned by practice of the presented embodiments of the disclosure.

In order to achieve the objects described above, a rotating window sensor cleaning system includes: a frame having a space therein; a camera or a sensor fixed inside the frame; a window which is transparent, and arranged in front of the camera or the sensor and mounted to be rotatable with respect to the frame; and a wiper blade fixed to the frame and mounted to be in sliding contact with the window, wherein the window may be configured to be rotated by a motor fixed to the frame, the window may be configured in a form of a disk, the window may be mounted to be rotatable in a window guide housing fixed to the frame, the window guide housing may include a first waterproof wall that protrudes along an outer circumferential surface having a cylindrical shape and is coupled to a first waterproof groove formed in the frame, and a reinforcing structure that is connectable to a rotation shaft of the motor may be mounted in a center of the window.

The window guide housing may include a second waterproof wall formed to surround an edge of the window.

The rotating window sensor cleaning system may further include a drain hole which is located under the window to discharge moisture that comes in contact with a front surface of the window in a downward direction of the frame.

The rotating window sensor cleaning system may further include a spray nozzle which is arranged above the frame and is configured to spray washer fluid toward the front surface of the window, may be provided.

The frame may include: a body having open front and rear sides; a front cap assembled to cover an open front portion of the body and including an observation hole formed at a position corresponding to the camera or the sensor; and a rear cap assembled to cover an open rear portion of the body and including a connection mounting hole electrically connected to the camera or the sensor.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view of an apparatus including a sensor cleaning system, according to an embodiment of the disclosure;

FIG. 2 is a view of the apparatus shown in FIG. 1 viewed in another direction;

FIG. 3 is an exploded perspective view of the apparatus shown in FIG. 1;

FIG. 4 is a cross-sectional view of the apparatus of FIG. 1 taken along line IV-IV;

FIG. 5 is a diagram illustrating a state in which a front cap is removed from the apparatus shown in FIG. 1;

FIG. 6 is a diagram illustrating a state in which a rear cap is removed from the apparatus shown in FIG. 1; and

FIG. 7 is a cross-sectional view of the apparatus of FIG. 6 taken along line VII-VII′.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments according to the disclosure will be described in more detail with reference to the accompanying drawings.

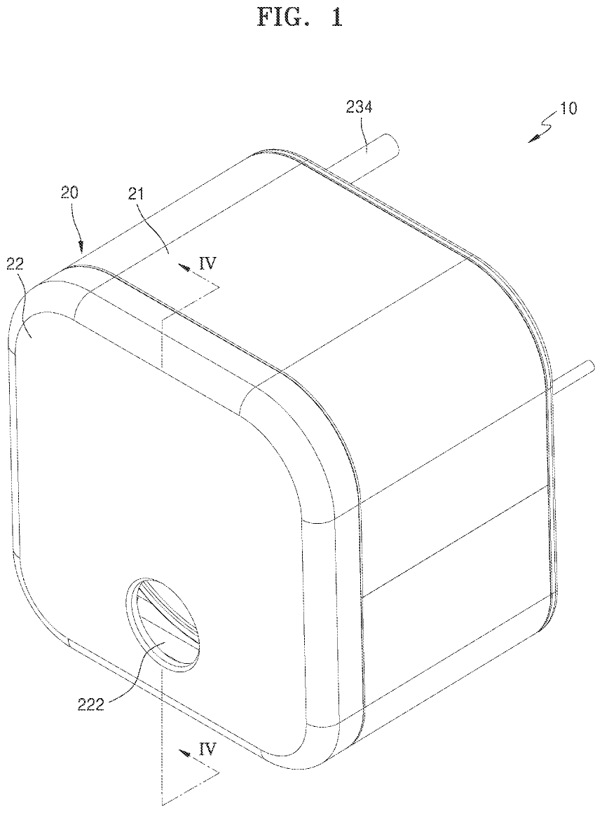

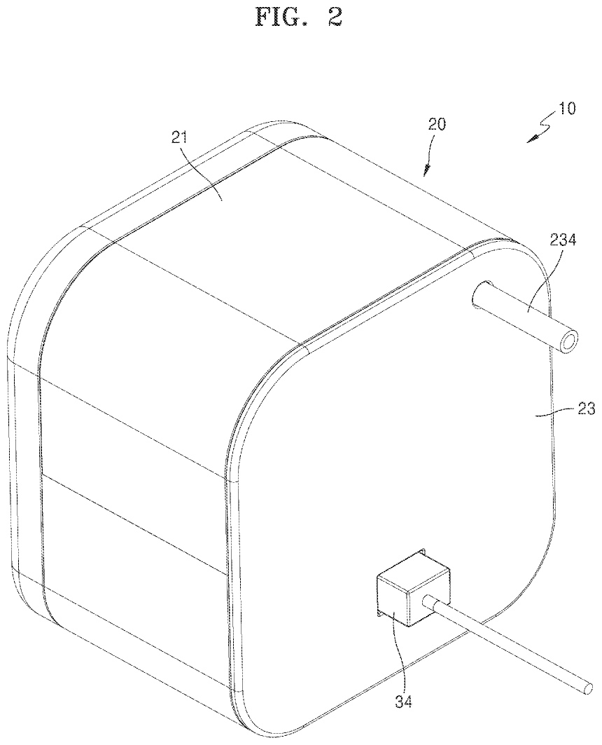

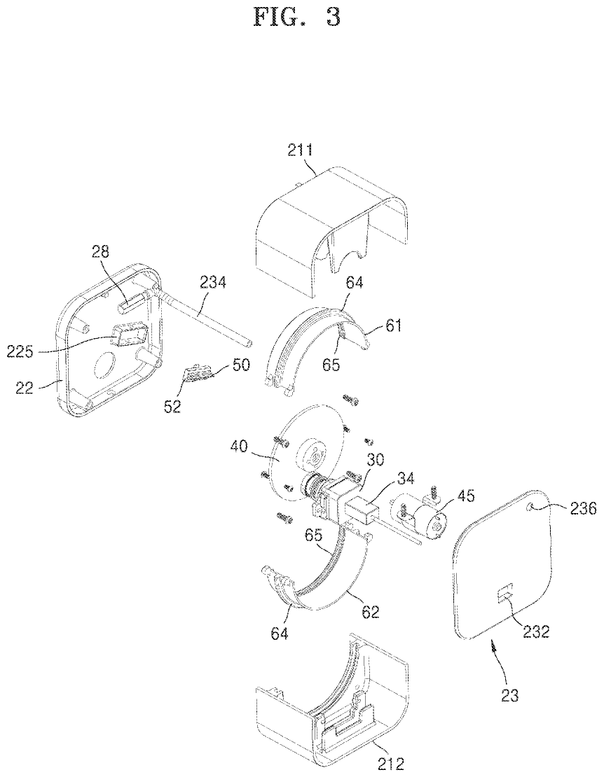

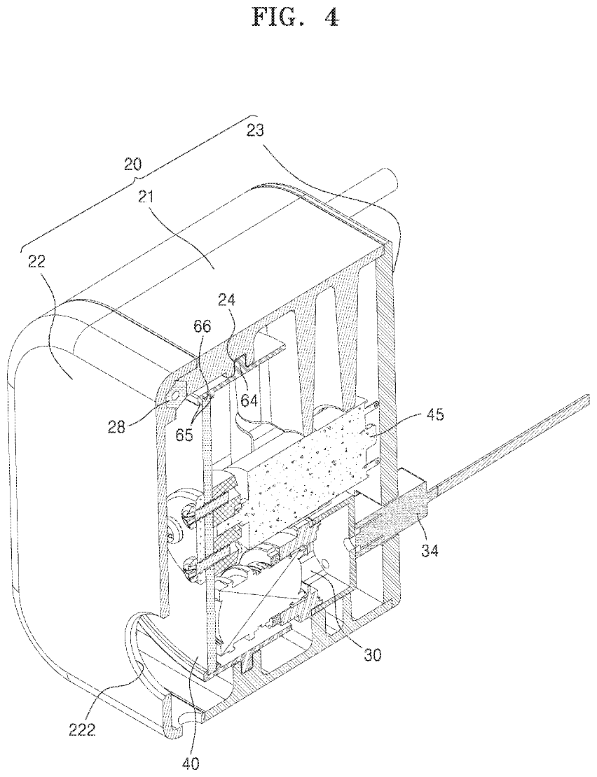

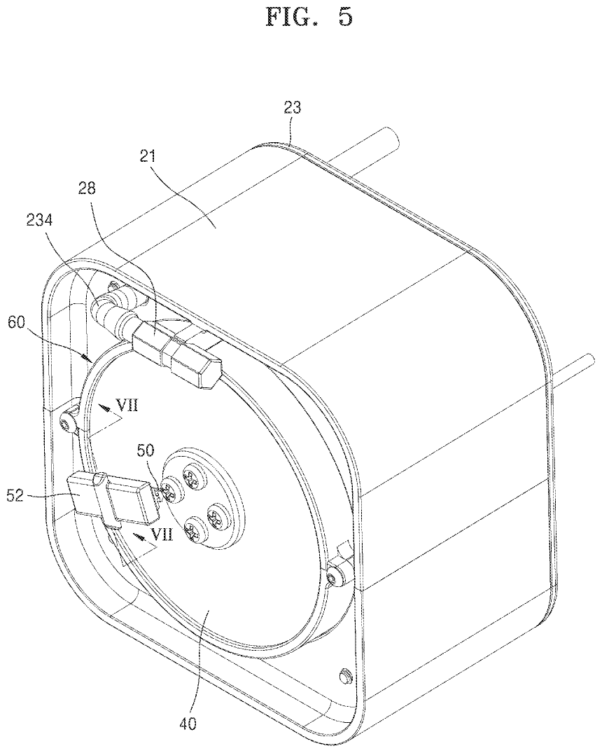

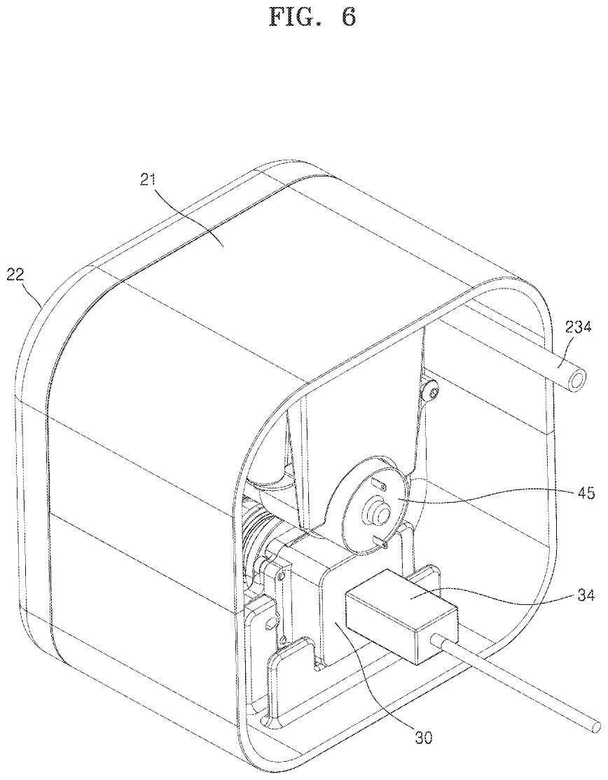

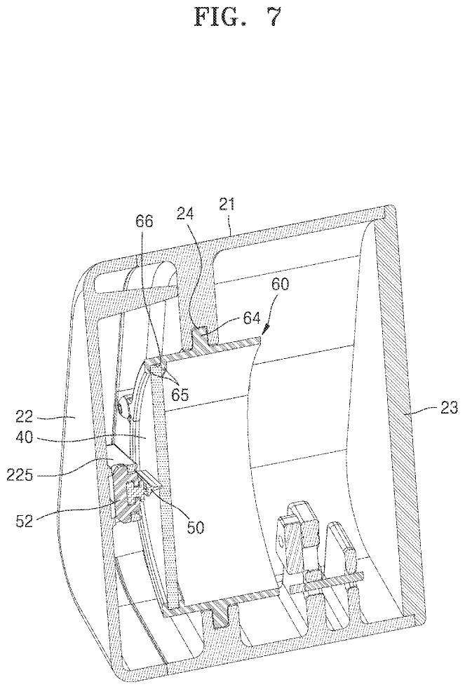

FIG. 1 is a perspective view of an apparatus including a sensor cleaning system, according to an embodiment of the disclosure. FIG. 2 is a view of the apparatus shown in FIG. 1 viewed in another direction. FIG. 3 is an exploded perspective view of the apparatus shown in FIG. 1. FIG. 4 is a cross-sectional view of the apparatus of FIG. 1 taken along line IV-IV. FIG. 5 is a diagram illustrating a state in which a front cap is removed from the apparatus shown in FIG. 1. FIG. 6 is a diagram illustrating a state in which a rear cap is removed from the apparatus shown in FIG. 1. FIG. 7 is a cross-sectional view of the apparatus of FIG. 6 taken along line VII-VII′.

Referring to FIGS. 1 to 7, a rotating window sensor cleaning system 10 includes a frame 20, a camera 30, a window 40, a wiper blade 50, a window guide housing 60, a first waterproof wall 64, a second waterproof wall 65, a drain hole 26, and a spray nozzle 28,

The frame 20 is a structure including a space therein.

The frame 20 includes a body 21, a front cap 22, and a rear cap 23.

The body 21 is a structure with open front and rear sides. An upper body 211 and a lower body 212 may be coupled to each other to constitute the body 21. The upper body 211 includes a support structure in which a motor 45, which will be described below, may be fixed and mounted. The support structure may be a cantilever-shaped structure extending downward from the ceiling of the upper body 211.

The lower body 212 includes a structure in which the camera 30, which will be described below, may be mounted. The upper body 211 and the lower body 212 may be coupled by a screw or may be coupled by bonding or thermal fusion.

The front cap 22 is assembled to the body 21 to cover an open front portion of the body 21. The front cap 22 may be fixed to the body 21 by a means such as a screw. The front cap 22 includes an observation hole 222. The observation hole 222 is provided at a position corresponding to a lens of the camera 30 or a sensor.

The rear cap 23 is assembled to the body 21 to cover an open rear portion of the body 21. The rear cap 23 may be fixed to the body 21 by a means such as a screw. The rear cap 23 includes a connection mounting hole 232. A connector 34 electrically connected to the camera 30 or the sensor is mounted in the connection mounting hole 232. The rear cap 23 may include a hose mounting hole 236 through which a hose 234 passes. The hose 234 is a passage through which washer fluid is supplied to the spray nozzle 28 that sprays the washer fluid.

The camera 30 is fixed inside the frame 20. Another optical sensor may be mounted instead of the camera 30. As the optical sensor, a sensor that measures a distance from a surrounding geographic feature by light may be used. The camera 30 may be mounted in a rib-shaped structure formed on the inner bottom surface of the lower body 212.

Transparent glass may be used as the window 40. As the window 40, it is preferable that disk-shaped glass with a circular outer rim is used. A reinforcing structure that may be connected to a rotation axis of the motor 45 may be mounted in the center of the window 40. The center of rotation of the window 40 and the rotation axis of the motor 45 are coaxial. The window 40 is arranged in front of the camera 30 or the sensor. The window 40 is mounted to be rotatable with respect to the frame 20.

The wiper blade 50 is fixed to the frame 20. For example, the wiper blade 50 may be replaceably mounted in a wiper mounting portion 225 provided on the inner surface of the front cap 22. The wiper blade 50 may be mounted so that a blade holder 52 is fixed at a predetermined position of the wiper mounting portion 225. Rubber constituting the wiper blade 50 is replaceably configured in the blade holder 52. The wiper blade 50 is mounted to be in sliding contact with the window 40. In more detail, the wiper blade 50 is mounted to be in contact with the front surface of the window 40. The window 40 is configured to be rotated by the motor 45 fixed to the frame 20.

In more detail, the motor 45 is fixed and mounted in the body 21. The rotation axis of the motor 45 is fixed to the center of the window 40. Accordingly, when the rotation shaft of the motor 45 rotates, the window 40 rotates. As the window 40 rotates, the window 40 comes into sliding contact with the wiper blade 50, so that foreign matter attached to the surface of the window 40 may be removed.

The window guide housing 60 is fixed to the frame 20. The window guide housing 60 is a structure with an overall cylindrical shape. The window 40 is mounted to be rotatable in the window guide housing 60. The window guide housing 60 may be configured by coupling an upper housing 61 to a lower housing 62. The upper housing 61 and the lower housing 62 may be fixed to each other by a screw.

The window guide housing 60 includes the first waterproof wall 64 and the second waterproof wall 65.

The first waterproof wall 64 is a structure protruding in the form of a rail along the outer circumferential surface of the window guide housing 60 having a cylindrical shape. The first waterproof wall 64 blocks foreign matter such as dust or moisture from entering the motor 45 or the camera 30 along the outer circumferential surface of the window guide housing 60. The first waterproof wall 64 is coupled to a first waterproof groove 24 formed in the body 21 constituting the frame 20, so that the waterproof function may be doubled.

The second waterproof wall 65 is a structure protruding in the form of a rail along the inner circumferential surface of the window guide housing 60. The second waterproof wall 65 includes a second waterproof groove 66 to surround the outer edge of the window 40. The outer edge of the window 40 rotates while being accommodated in the second waterproof groove 66 to prevent moisture or foreign matter from entering through a gap between the window 40 and the window guide housing 60, so that the waterproof effect is implemented. Because the window 40 is mounted to be rotatable with respect to the window guide housing 60, a fine gap exists between the window 40 and the second waterproof groove 66. Nevertheless, the second waterproof wall 65 blocks a path of foreign matter when the foreign matter penetrates in a direction perpendicular to the window 40, so that the waterproof effect may be implemented.

The drain hole 26 is arranged under the window 40. The drain hole 26 is a hole that discharges moisture in contact with the front surface of the window 40 to the lower side of the frame 20.

The spray nozzle 28 is arranged above the frame 20. The spray nozzle 28 is a device that sprays washer fluid toward the front surface of the window 40. The spray nozzle 28 may be supplied with the washer fluid from the outside through the hose 234.

Hereinafter, the effects of the rotating window sensor cleaning system 10 including the aforementioned elements will be described in detail.

Referring to FIGS. 3 to 5, when the window 40 arranged in front of the lens of the camera 30 is contaminated by foreign matter, an electrical signal is applied to the motor 45. Accordingly, the motor 45 operates. As the motor 45 operates, the rotation shaft of the motor 45 rotates. Accordingly, the window 40 rotates integrally with the rotation shaft of the motor 45. As the window 40 rotates, the window 40 comes into sliding contact with the wiper blade 50 fixed to the body 21, so that foreign matter attached to the window 40 is removed.

As described above, the rotating window sensor cleaning system according to the disclosure is configured so that the window rotates while a wiper blade does not rotate. Because the window is configured to rotate, the wiper blade does not block the front of a camera or a sensor compared to a case where the wiper blade is configured to move, and thus, the operation performance of the camera or the sensor may not be interfered. Also, because the wiper blade may be mounted inside a front cover, there is no structure protruding to the outside. Accordingly, a wiper may not be damaged by an unexpected external impact during an assembly process or an operation process. Therefore, the durability of the sensor cleaning system may be improved compared to the wiper systems of the related art. Also, the wiper blade does not protrude to the outside and thus occupies less package space, which improves the assemblability of the sensor cleaning system.

The sensor cleaning system according to the disclosure is configured so that the wiper blade is maintained in a fixed state and a transparent window in contact with the wiper blade is rotated by a motor, and thus the wiper blade does not cause any operation error of a camera or sensor device, which is applied outside of an autonomous vehicle during an operation process of the camera or sensor device, thereby ensuring stable operation performance of the device. Also, the sensor cleaning system according to the disclosure has a structure in which the wiper blade does not rotate but is fixed, and thus may have a simpler structure and smaller volume, so that the package assemblability and durability thereof may be significantly enhanced.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A rotating window sensor cleaning system comprising:
a frame having a space therein;
a camera or a sensor fixed inside the frame;
a window which is transparent, and arranged in front of the camera or the sensor and mounted to be rotatable with respect to the frame; and
a wiper blade fixed to the frame and mounted to be in sliding contact with the window,
wherein the window is configured to be rotated by a motor fixed to the frame,
the window is configured in a form of a disk,
the window is mounted to be rotatable in a window guide housing fixed to the frame,
the window guide housing includes a first waterproof wall that protrudes along an outer circumferential surface having a cylindrical shape and is coupled to a first waterproof groove formed in the frame, and
a reinforcing structure that is connectable to a rotation shaft of the motor is mounted in a center of the window.

2. The rotating window sensor cleaning system of claim 1, wherein the window guide housing includes a second waterproof wall formed to surround an edge of the window.

3. The rotating window sensor cleaning system of claim 1, further comprising a drain hole which is located under the window to discharge moisture that comes in contact with a front surface of the window in a downward direction of the frame.

4. The rotating window sensor cleaning system of claim 3, further comprising a spray nozzle which is arranged above the frame and is configured to spray washer fluid toward the front surface of the window.

5. The rotating window sensor cleaning system of claim 1, wherein the frame includes:
a body having open front and rear sides;
a front cap assembled to cover an open front portion of the body and including an observation hole formed at a position corresponding to the camera or the sensor; and
a rear cap assembled to cover an open rear portion of the body and including a connection mounting hole electrically connected to the camera or the sensor.
